(19) United States
(12) Patent Application Publication
(10) Pub. No.: US 2009/0019477 A1
(43) Pub. Date: Jan. 15, 2009

(54) DATA SEARCH METHOD AND DATA BROADCAST TRANSMITTING AND RECEIVING APPARATUSES

(75) Inventors: Ju-ho HYUN, Suwon-si (KR); Hae-sik Jun, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/926,269

(22) Filed: Oct. 29, 2007

(30) Foreign Application Priority Data
Jul. 9, 2007 (KR) 10-2007-0068840

(51) Int. Cl. G06F 3/00; G06F 17/30

(52) U.S. Cl. 725/38; 707/3; 707/E17.014

(57) ABSTRACT

Provided are a data search method and data broadcast transmitting and receiving apparatuses. The data search method includes receiving a data search request; tuning a channel and receiving data to conduct a data search; obtaining a data search descriptor from the received data and conducting the data search; and outputting search results.

This application claims priority from Korean Patent Application No. 10-2007-0068840 filed on Jul. 9, 2007 in the Korean Intellectual Property Office, the disclosure of which is incorporated herein by reference in its entirety.

### BACKGROUND OF THE INVENTION

1. Field of the Invention

The present invention relates to a data search method and data broadcast transmitting and receiving apparatuses, and more particularly, to a data search method and data broadcast transmitting and receiving apparatuses which can easily find desired data in data broadcasts.

2. Description of the Related Art

Digital broadcasting is an advanced broadcasting technology that can perform bi-directional transmission, and reproduction and storage of data differently from analog broadcasting. In digital broadcasting, television signals are compressed and broadcast as digital signals in which coded data signals are recorded. Since the number of signals that can be transferred via digital broadcasting is six times larger than in analog broadcasting, the resolution of signals in digital broadcasting is at least twice as high as in analog broadcasting. Also, because a digital radio signal can store a plurality of video and audio files, six to eight channels can be operated in the same bandwidth in digital broadcasting, in contrast to one channel in analog broadcasting. As such, digital broadcasting has become a core technology of the comprehensive information media era. In digital broadcasting, video and audio files can be compressed and transmitted and various signals can be modulated by using computer-based or communication-based technologies. Changes brought about by this digital broadcasting environment are transforming a television from a traditionally passive device into an active multimedia device functioning as an interactive computer.

Data broadcasting, which is rapidly gaining popularity, is the core of digital broadcasting. Data broadcasting is the continuous transfer of digital/multimedia broadcast contents, in addition to video files, audio files, software applications and streaming information, to an information processing apparatus, such as a personal computer (PC), a digital set-top box, and a personal portable terminal. Data broadcasting, by its nature, does not require a return path, and the information processing apparatus receives contents without requesting them. Thus, data broadcasting is a new media communication alternative which can solve the simplicity of conventional analog broadcasting and limitations concerning Internet service capacity. That is, in technological aspects, data broadcasting is a highly advanced technology combining broadcasting, communication and the Internet. Data broadcasting provides viewers with bi-directional multimedia contents, which can be enjoyed over the Internet, using the advantages of broadcasting in which large data can be transmitted at a very high speed. Hence, data broadcasting is an application technology that can solve the one way property and simplicity of conventional analog broadcasting and limitations concerning the image quality, audio quality and capacity of Internet broadcasting by using a digital broadcasting system.

Examples of digital broadcasting systems include the Advanced Television Systems Committee (ATSC) system used in the U.S. and the Digital Video Broadcasting-Terrestrial (DVB-T) system used in Europe as ground wave receiving systems, and an OpenCable system used in the U.S. and a DVB-Cable (DVB-C) system used in Europe as cable receiving systems. Examples of a middleware standard for receiving digital broadcasting include the DVB-Multimedia Home Platform (DVB-MHP), the OpenCable Application Platform (OCAP), and the Advanced Common Application Platform (ACAP). The DVB-MHP is a middleware system for a European digital television designed by a DVB project. The OCAP is a middleware system for a digital cable television set-top box and other digital devices adopted by cable companies in the U.S. The ACAP has been designed to unify the OCAP used in cable broadcasting and a digital television application software environment (DASE) used in ground wave broadcasting.

The DVB-MHP, OCAP, and ACAP use an object carousel defined by the International Organization for Standardization (ISO)-International Electrotechnical Commission (IEC) 13818-6 standard. The object carousel uses a common object request broker architecture (CORBA) string defined in a CORBA/Internet inter-ORB protocol (IIOP) 2.1 specification in order to exchange a pathname component which is used to name information, in particular, directories and files. In addition, when character encoding data is not specified in the CORBA string, the object carousel uses the ISO 8859-1 (ISO Latin 1) standard for an encoding system. Accordingly, these middleware technologies using the object carousel, such as the DVB-MHP, the OCAP and the ACAP, use the ISO 8859-1 standard as a basic encoding system for naming pathnames, i.e., files and directories.

However, there is still much room for support in data broadcasting to enable a user to sufficiently use received data. In particular, a data search support is most important. Even if data broadcasting provides user created contents (UCC), MP3, and various files and applications, it is difficult for a user to know what data or application is currently being provided on which of numerous data broadcast channels. In addition, it is difficult for the user to know which of the numerous data broadcast channels is providing desired data.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a data search method and data broadcast transmitting and receiving apparatuses which can search for data and an application in real time.

According to an aspect of the present invention, there is provided a data broadcast transmitting apparatus including a transmission control unit generating a data search descriptor which describes content of data; a data encoder encoding the data search descriptor generated by the transmission control unit and the data; and a transmission unit transmitting the data encoded by the data encoder.

According to another aspect of the present invention, there is provided a data broadcast receiving apparatus including a reception unit receiving data broadcasts; a data decoder decoding data received by the reception unit and obtaining a data search descriptor, which describes content of the data in order to search for the data; a reception control unit searching for the data using the data search descriptor obtained by the data decoder; and an output unit outputting search results of the reception control unit.

According to another aspect of the present invention, there is provided a data search method including receiving a data search request; tuning a channel and receiving data to conduct a data search; obtaining a data search descriptor from the received data and conducting the data search; and outputting search results.

### BRIEF DESCRIPTION OF THE DRAWINGS

The above and other aspects of the present invention will become more apparent by describing in detail exemplary embodiments thereof with reference to the attached drawings in which:

FIG. 1 is a schematic diagram illustrating a data broadcasting system according to an exemplary embodiment of the present invention;

FIG. 2 is a block diagram of a data broadcast transmitting apparatus according to an exemplary embodiment of the present invention;

FIG. 3 is a block diagram of a data broadcast receiving apparatus according to an exemplary embodiment of the present invention;

FIG. 4 is a flowchart illustrating a data search method according to an exemplary embodiment of the present invention;

FIG. 5 illustrates data search results according to an exemplary embodiment of the present invention; and

FIGS. 6 and 7 illustrate the format of a data search descriptor according to an exemplary embodiment of the present invention.

### DETAILED DESCRIPTION OF EXEMPLARY EMBODIMENTS OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. Like reference numerals in the drawings denote like elements, and thus their description will be omitted.

Hereinafter, the present invention will be described with reference to block diagrams or flowchart illustrations. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus, such that the instructions, which execute via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

And each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

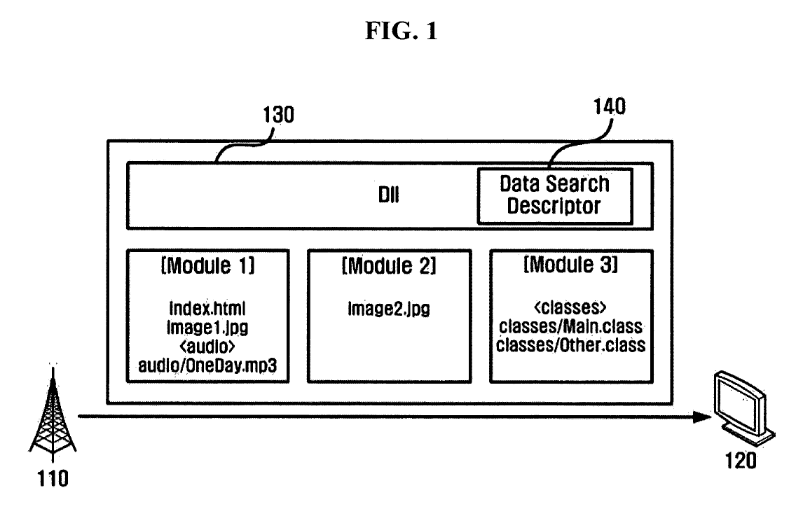

FIG. 1 is a schematic diagram illustrating a data broadcasting system according to an exemplary embodiment of the present invention.

Referring to FIG. 1, a data broadcast transmitting apparatus 110 transmits a data service, which contains a file and a directory, as a Moving Picture Experts Group (MPEG)-2 transport stream according to the Digital Storage Media Command and Control (DSM-CC) standard. In this case, the data broadcast transmitting apparatus 110 transmits the data service using a data transmission method such as data piping, data streaming, multi-protocol encapsulation, a data carousel, or an object carousel. An object carousel defined by the DSM-CC standard may be used.

The data broadcast transmitting apparatus 110 inserts a data search descriptor 140 into a download info indication (DII) 130 defined by the DSM-CC standard and transmits the DII 130 accordingly. Alternatively, the data broadcast transmitting apparatus 110 may insert the data search descriptor 140 into a service information (SI) table defined by the DSM-CC standard and transmit the SI table accordingly.

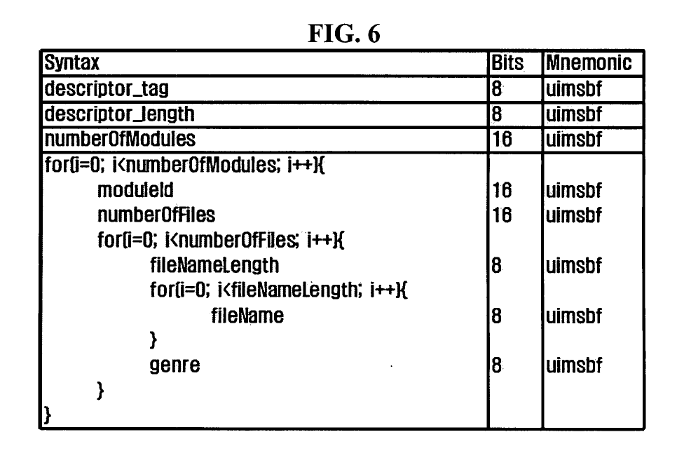

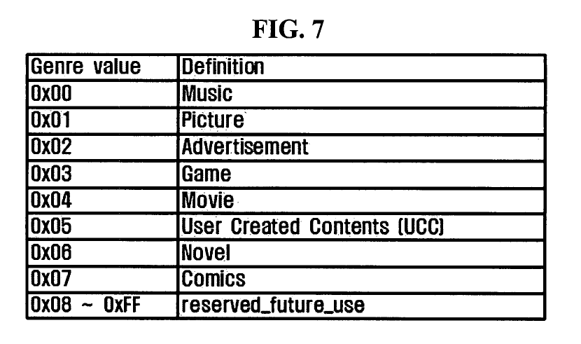

The data search descriptor 140 includes a filename and a genre contained in each module. The format of the data search descriptor 140 is as illustrated in FIGS. 6 and 7.

When a data search request is received, a data broadcast receiving apparatus 120 tunes each channel and obtains the data search descriptor 140 from the DII 130 of the data service. Then, the data broadcast receiving apparatus 120 searches for data using the data search descriptor 140 which is obtained. Therefore, the data broadcast receiving apparatus 120 can easily search for the data without decoding each module and checking each filename.

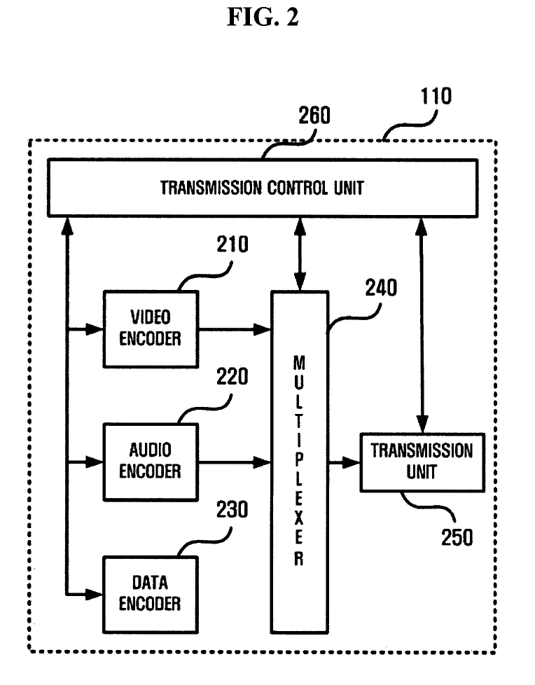

FIG. 2 is a block diagram of a data broadcast transmitting apparatus 110 according to an exemplary embodiment of the present invention.

Referring to FIG. 2, a video encoder 210 encodes video data, generates a video bitstream, and provides the video bitstream to a multiplexer 240. An audio encoder 220 encodes audio data, generates an audio bitstream, and provides the audio bitstream to the multiplexer 240.

A data encoder 230 encodes a data search descriptor 140 and data and generates a bitstream. The data search descriptor 140 may be included in an SI table or DII. The data encoder 230 may encode the data using an object carousel, and the data search descriptor 140 may be included in DII of the object carousel. The data search descriptor 140 includes filename and genre contained in the data. The format of the data search descriptor 140 is as illustrated in FIGS. 6 and 7.

The multiplexer 240 multiplexes the bitstreams generated by the video encoder, the audio encoder and the data encoder, generates one or more transport streams, and provides the transport streams to a transmission unit 250.

The transmission unit 250 modulates the transport streams into signals that can be output and transmits the signals. In this case, the transmission unit 250 may modulate the transport streams into MPEG-2 transport streams according to the DSM-CC standard and transmit the MPEG-2 transport streams.

A transmission control unit 260 generates the data search descriptor 140. The transmission control unit 260 controls the operation of each component of the data broadcast transmitting apparatus 110 and generates an object carousel message such as a DSI message, a DII message containing the data search descriptor 140, or a DBB message.

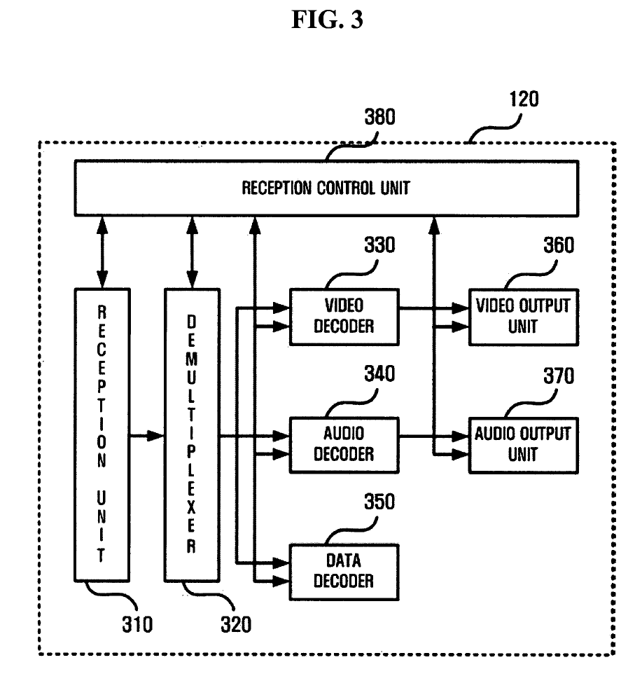

FIG. 3 is a block diagram of a data broadcast receiving apparatus 120 according to an exemplary embodiment of the present invention.

Referring to FIG. 3, a reception unit 310 receives data broadcasts. The reception unit 310 modulates a received signal into a transport stream and provides the transport stream to a demultiplexer 320. Using a filter, the demultiplexer 320 selects a packetized elementary stream (PES) packet, which corresponds to a program selected by a user, from a transport stream into which a number of PES's are multiplexed. In the case of data search, only a data stream is selected.

A video decoder 330 and an audio decoder 340 decode the PES selected by the demultiplexer 320 into a format that can be output and output a data broadcast using a video output unit 360 and an audio output unit 370. In the case of data search, the video decoder 330 and the audio decoder 340 remain idle.

A data decoder 350 decodes data and obtains a data search descriptor 140 which describes the content of the data. Generally, the data decoder 350 decodes a DSM-CC section of an MPEG-2 transport stream, which is used by an object carousel, according to each specification. However, in the case of data search, the data decoder 350 obtains only the data search descriptor 140 from an SI table or DII of an object carousel.

A reception control unit 380 searches for data using the data search descriptor 140. The reception control unit 380 controls the operation of each component of the data broadcast receiving apparatus 120 and interprets an object carousel message received from a data broadcast transmitting apparatus, such as a DSI message, a DII message, or a DBB message. The reception control unit 380 performs a data search by interpreting the data search descriptor 140 and comparing it with an input search word. The reception control unit 380 transmits search results to the video output unit 360, which, in turn, outputs the search results.

The reception control unit 380 determines whether an idle tuner exists. Generally, a digital television has two tuners in order to support a picture-in-picture (PIP) function. Therefore, while one of the two tuners receives broadcasts, the other one remains idle. When there is an idle tuner, the reception control unit 380 performs a tuning operation using the idle tuner in order to conduct a data search.

The reception control unit 380 obtains channel information from a channel map and tunes each channel one by one for data search. The reception control unit 380 determines whether all channels have been searched and tunes each channel until all channels are searched.

The reception control unit 380 determines whether a data service exists on a channel being tuned. The reception control unit 380 determines whether an object carousel, which is defined by the DSM-CC standard, exists on the channel being tuned. The reception control unit 380 operates the data decoder 350 only when the data service exists on the channel being tuned and conducts a data search.

The term “unit”, as used herein, means, but is not limited to, a software or hardware component, such as a Field Programmable Gate Array (FPGA) or Application Specific Integrated Circuit (ASIC), which performs certain tasks. A unit may advantageously be configured to reside on the addressable storage medium and configured to be executed on one or more processors. Thus, a unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units may be combined into fewer components and units or further separated into additional components and units. In addition, the components and modules may be implemented to execute one or more central processing units (CPUs) in a device or a security multimedia card.

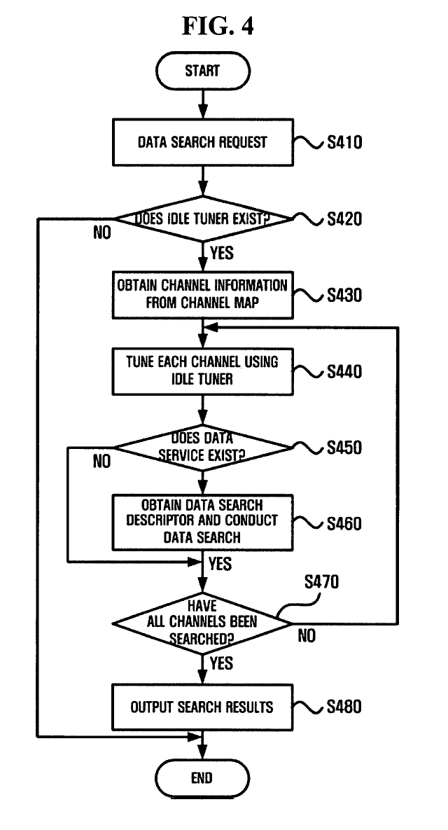

FIG. 4 is a flowchart illustrating a data search method according to an exemplary embodiment of the present invention.

Referring to FIG. 4, a user requests the data broadcast receiving apparatus 120 to perform a data search (operation S410). When the data search request is received, the reception control unit 380 of the data broadcast receiving apparatus 120 determines whether an idle tuner exists (operation S420). If it is determined that the idle tuner does not exist, the reception control unit 380 stops a data search.

If it is determined that the idle tuner exists, the reception control unit 380 obtains channel information from a channel map (operation S430). The reception control unit 380 obtains channel information so that all channels can be searched.

The reception control unit 380 tunes each channel one by one using the idle tuner (operation S440). The reception control unit 380 operates the reception unit 310 to receive a data broadcast from each channel.

The reception control unit 380 determines whether a data service exists on a channel from which the reception unit 310 is receiving a broadcasting data (operation S450). Alternatively, the reception control unit 380 may determine whether an object carousel defined by the DSM-CC standard exists on a channel being tuned. If it is determined that the data service does not exist on the channel, the reception control unit 380 determines whether all channels have been searched (operation S470) in order to search unsearched channels.

If it is determined that the data service exists on the channel, the reception control unit 380 operates the data decoder 350. The data decoder 350 decodes data and obtains the data search descriptor 140, and the reception control unit 380 searches for data using the obtained data search descriptor 140 (operation S460). The data decoder 350 obtains the data search descriptor 140 from an SI table or DII of an object carousel. The reception control unit 380 performs a data search by interpreting the obtained data search descriptor 140 and comparing it with an input search word.

The reception control unit 380 determines whether all channels have been searched (operation S470). In this case, the reception control unit 380 determines whether all channels have been searched based on the channel information obtained from the channel map. If it is determined that all channels have not been searched, the reception control unit 380 tunes another channel (operation S440).

If it is determined that all channels have been searched, the reception control unit 380 transmits search results to the video output unit 360, which, in turn, outputs the search results (operation S480).

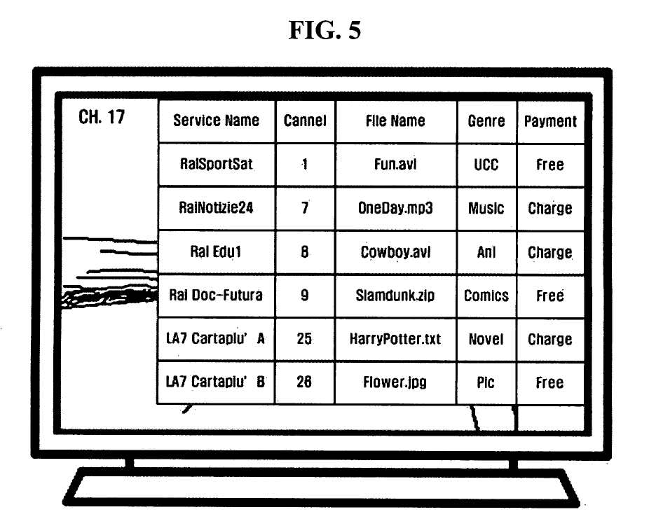

FIG. 5 illustrates data search results according to an exemplary embodiment of the present invention.

Referring to FIG. 5, found filenames, genre, payment, and channel information are displayed so that a user can use found data.

FIGS. 6 and 7 illustrate the format of the data search descriptor 140 according to an exemplary embodiment of the present invention.

Referring to FIG. 6, the data search descriptor 140 specifies the number of modules contained in data, a filename contained in each module, a length of a filename for parsing the filename, and information regarding genre. Referring to FIG. 7, a value is given to each genre.

As described above, a data search method and data broadcast transmitting and receiving apparatuses according to the present invention may provide one or more of the following advantages.

First, data and an application included in a data broadcast can be searched for in real time.

Second, a quick search can be conducted using a data search descriptor and at a low load.

Third, an idle tuner can be utilized.

However, the effects of the present invention are not restricted to the one set forth herein. The above and other effects of the present invention will become more apparent to one of daily skill in the art to which the present invention pertains by referencing the claims.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A data broadcast transmitting apparatus comprising:
a transmission control unit which generates a data search descriptor which describes content of data;
a data encoder which encodes the data search descriptor generated by the transmission control unit and the data; and
a transmission unit which transmits the data encoded by the data encoder.

2. The apparatus of claim 1, wherein the data search descriptor comprises at least one of a number of modules, a number of files, a filename, and a genre of the data.

3. The apparatus of claim 1, wherein the transmission control unit generates the data search descriptor in a service information table.

4. The apparatus of claim 1, wherein the transmission control unit generates the data search descriptor in a download info indication.

5. The apparatus of claim 1, wherein the data encoder encodes the data search descriptor and the data and generates an object carousel.

6. The apparatus of claim 1, wherein the transmission unit modulates the encoded data into a Moving Picture Experts Group (MPEG)-2 transport stream according to the Digital Storage Media Command and Control standard and transmits the MPEG-2 transport stream.

7. The apparatus of claim 1, further comprising:
a video encoder which encodes video data and generates a video bitstream;
an audio encoder which encodes audio data and generates an audio bitstream; and
a multiplexer which multiplexes bitstreams generated by the data encoder, the video encoder and the audio encoder and generates a transport stream.

8. A data broadcast receiving apparatus comprising:
a reception unit which receives data broadcasts;
a data decoder which decodes data received by the reception unit and obtains a data search descriptor, which describes content of the data in order to search the data;
a reception control unit which searches the data using the data search descriptor obtained by the data decoder; and
an output unit which outputs search results of the reception control unit.

9. The apparatus of claim 8, wherein the reception control unit determines whether an idle tuner exists.

10. The apparatus of claim 8, wherein the reception control unit obtains channel information from a channel map, tunes each channel individually, and determines whether all channels have been searched.

11. The apparatus of claim 8, wherein the reception control unit determines whether a data service exists on a channel being tuned.

12. The apparatus of claim 8, wherein the data decoder obtains the data search descriptor from a service information table.

13. The apparatus of claim 8, wherein the data decoder obtains the data search descriptor from a download info indication.

14. The apparatus of claim 8, wherein the data search descriptor comprises at least one of a number of modules, a number of files, a filename, and a genre.

15. The apparatus of claim 8, wherein the search results output from the output unit comprise at least one of service name, channel number, filename, genre, and payment.

16. The apparatus of claim 8, further comprising a demultiplexer selecting and extracting a data stream from a multiplexed transport stream.

17. A data search method comprising:
receiving a data search request;
tuning a channel and receiving data to conduct a data search;
obtaining a data search descriptor from the received data and conducting a data search; and
outputting search results.

18. The method of claim 17, further comprising determining whether the data exists on the channel being tuned.

19. The method of claim 17, further comprising:
obtaining channel information from a channel map; and
determining whether all channels indicated by the channel information have been tuned.

20. The method of claim 17, further comprising determining whether an idle tuner exists, wherein the channel is tuned using the idle tuner.

21. The method of claim 17, wherein the data search descriptor is obtained from a service information table.

22. The method of claim 17, wherein the data search descriptor is obtained from a download info indication.

23. The method of claim 17, wherein the data search descriptor comprises at least one of a number of modules, a number of files, a filename, and a genre.

24. The method of claim 17, wherein the search results comprise at least one of a service name, a channel number, a filename, a genre, and a payment.
